(19) United States
(12) Patent Application Publication
(10) Pub. No.: US 2015/0275802 A1
(43) Pub. Date: Oct. 1, 2015

(54) INTERNAL COMBUSTION ENGINE AND CONTROLLER THEREFOR

(71) Applicant: Toyota Jidosha Kabushiki Kaisha, Toyota-shi Aichi-ken (JP)

(72) Inventor: Fumio Takamiya, Gotemba-shi Shizuoka-ken (JP)

(21) Appl. No.: 14/662,660

(22) Filed: Mar. 19, 2015

(30) Foreign Application Priority Data
Mar. 25, 2014 (JP) 2014-062159

(51) Int. Cl. F02D 41/14; F02B 37/18; F02D 41/00; F02D 41/38; F02D 13/02

(52) U.S. Cl. CPC F02D 41/1454; F02D 41/38; F02D 13/0261; F02D 13/0242; F02D 41/0007; F02B 37/183; F02D 41/1443; F02D 2041/001; F02D 2041/389

(57) ABSTRACT

For each of banks and, the fuel injection amount is changed under a consistent operating condition in which scavenging occurs, and the scavenging amount is calculated from the exhaust gas air fuel ratio at the time when the indicated torque based on the detection value of an in-cylinder pressure sensor is at the maximum. If the scavenging amount differs between the banks, the valve overlapping period of a relevant one of the banks and is controlled to reduce the difference of the scavenging amount between the banks.

### BACKGROUND OF THE INVENTION

1. Field of the Invention

The present invention relates to an internal combustion engine and a controller for an internal combustion engine.

2. Background Art

Japanese Patent Laid-Open No. 2013-024203 (hereinafter referred to as Patent Literature 1) discloses a conventional controller for a direct injection internal combustion engine with a supercharger. The conventional controller determines the ratio of the amount of air blowing into the exhaust gas channel to the amount of air passing through the intake valve (referred to as scavenging ratio in Patent Literature 1) by using a physical model (air model) of the response of the air amount in the cylinders to the operation of the throttle that is based on fluid mechanics. Based on the determined scavenging ratio, the controller corrects the target exhaust gas air fuel ratio to calculate the air fuel ratio in the cylinders.

In an internal combustion engine provided with two cylinder groups, such as a V internal combustion engine provided with two banks, the pressure of the gas flowing into the cylinders (intake gas pressure) or the pressure of the gas discharged from the cylinders (exhaust gas pressure) may differ between the cylinder groups because of plugging over time of catalysts or other components disposed in the exhaust gas channels, pressure losses or variations in components of the intake and exhaust system, or deterioration of the superchargers over time. Even if the cylinder groups have the same valve overlapping period of the intake valve and the exhaust valve, the amount of gas blowing through the cylinders (scavenging amount) differs between the cylinder groups if the difference between the intake gas pressure and the exhaust gas pressure differs between the cylinder groups. In evaluation of the scavenging amount of each cylinder group, if the effect of such deterioration over time or the like fails to be grasped, the fuel injection amount cannot be adjusted to achieve an appropriate air fuel ratio in the cylinders of the cylinder groups, resulting in overheating of the catalyst bed or decrease of torque or fuel efficiency, for example. According to the method based on the air model disclosed in Patent Literature 1, however, it is difficult to determine the scavenging amount for each cylinder group while grasping the effect of the deterioration over time or the like (more specifically, such a task is computationally intensive and cannot achieve adequate precision).

### SUMMARY OF THE INVENTION

The present invention has been devised to solve the problems described above, and an object of the present invention is to provide a controller for an internal combustion engine that can evaluate the scavenging amount of each cylinder groups based on an exhaust gas air fuel ratio regardless of the effect of deterioration over time of an intake and exhaust system or the like and can reduce the difference of the scavenging amount between the cylinder groups.

According to a first aspect of the present invention, an internal combustion engine includes: a first cylinder group, a second cylinder group, a supercharger, a fuel injection valve, a first exhaust gas channel, a second exhaust gas channel, a first air fuel ratio sensor, a second air fuel ratio sensor, in-cylinder pressure sensors, a first variable valve mechanism, a second variable valve mechanism, and a controller. The first cylinder group includes at least one cylinder having an intake valve and an exhaust valve. The second cylinder group includes at least one cylinder having an intake valve and an exhaust valve. The supercharger supercharges intake air. The fuel injection valve is provided for each cylinder of the first cylinder group and the second cylinder group, and the fuel injection valve directly injects fuel into the cylinder. The first exhaust gas channel is connected to the first cylinder group. The second exhaust gas channel is connected to the second cylinder group. The first air fuel ratio sensor detects an air fuel ratio of exhaust gas flowing through the first exhaust gas channel. The second air fuel ratio sensor detects an air fuel ratio of exhaust gas flowing through the second exhaust gas channel. The in-cylinder pressure sensors are provided for at least one cylinder of the first cylinder group and at least one cylinder of the second cylinder group. The first variable valve mechanism is capable of adjusting a first valve overlapping period in which both the intake valve and the exhaust valve of the first cylinder group are open. The second variable valve mechanism is capable of adjusting a second valve overlapping period in which both the intake valve and the exhaust valve of the second cylinder group are open. The controller controls the first variable valve mechanism and the second variable valve mechanism. The controller is programmed to obtain a first output value or a correlated value thereof from the first air fuel ratio sensor for exhaust gas discharged from the first cylinder group when an indicated work or a correlated value thereof based on a detection value of the in-cylinder pressure sensor of the first cylinder group is at the maximum while a fuel injection amount of the first cylinder group is changed under a consistent operating condition in which fresh air blows from an intake gas channel to an exhaust gas channel through a combustion chamber. The controller is further programmed to obtain a second output value or a correlated value thereof from the second air fuel ratio sensor for exhaust gas discharged from the second cylinder group when an indicated work or a correlated value thereof based on a detection value of the in-cylinder pressure sensor of the second cylinder group is at the maximum while a fuel injection amount of the second cylinder group is changed under the consistent operating condition. The controller is further programmed to control at least one of the first valve overlapping period and the second valve overlapping period to reduce an output value difference between the obtained first output value and the obtained second output value or a correlated value difference between the obtained correlated value of the first output value and the obtained correlated value of the second output value.

According to a second aspect of the present invention, in the internal combustion engine according to the first aspect, the supercharger includes: a first turbocharger provided with a first turbine disposed in the first exhaust gas channel, and a second turbocharger provided with a second turbine disposed in the second exhaust gas channel. According to the aspect, in the first aspect, the internal combustion engine further includes: a first exhaust gas bypass channel that bypasses the first turbine, a second exhaust gas bypass channel that bypasses the second turbine, a first waist gate valve that opens and closes the first exhaust gas bypass channel, a second waist gate valve that opens and closes the second exhaust gas bypass channel. According to the second aspect, in the first aspect, the controller further programmed to obtain a first indicated work or a correlated value thereof based on the detection value of the in-cylinder pressure sensor of the first cylinder group and a second indicated work or a correlated value thereof based on the detection value of the in-cylinder pressure sensor of the second cylinder group after the controller controls at least one of the first valve overlapping period and the second valve overlapping period to reduce the output value difference or the correlated value difference. According to the second aspect, in the first aspect, the controller further programmed to control an opening of at least one of the first waist gate valve and the second waist gate valve to reduce a difference between the obtained first indicated work and the obtained second indicated work or a difference between the obtained correlated value of the first indicated work and the obtained correlated value of the second indicated work.

According to a third aspect of the present invention, a controller for an internal combustion engine is provided. The internal combustion engine in the third aspect is provided with a first cylinder group including at least one cylinder, second cylinder group including at least one cylinder, a supercharger that supercharges intake air, a fuel injection valve provided for each cylinder of the first cylinder group and the second cylinder group, the fuel injection valve directly injecting fuel into the cylinder. The internal combustion engine in the third aspect is provided with a first exhaust gas channel connected to the first cylinder group, a second exhaust gas channel connected to the second cylinder group, a first air fuel ratio sensor that detects an air fuel ratio of exhaust gas flowing through the first exhaust gas channel, a second air fuel ratio sensor that detects an air fuel ratio of exhaust gas flowing through the second exhaust gas channel, in-cylinder pressure sensors provided for at least one cylinder of the first cylinder group and at least one cylinder of the second cylinder group. The internal combustion engine in the third aspect is provided with a first variable valve mechanism capable of adjusting a first valve overlapping period in which both an intake valve and an exhaust valve of the first cylinder group are open, a second variable valve mechanism capable of adjusting a second valve overlapping period in which both an intake valve and an exhaust valve of the second cylinder group are open. According to the third aspect, the controller includes an input part and first controlling means. The input part is connected to the first air fuel ratio sensor, the second air fuel ratio sensor, the first variable valve mechanism, and the second variable valve mechanism. The controlling means controls the first variable valve mechanism and the second variable valve mechanism. According to the third aspect, the first controlling means obtains a first output value or a correlated value thereof from the first air fuel ratio sensor for exhaust gas discharged from the first cylinder group when an indicated work or a correlated value thereof based on a detection value of the in-cylinder pressure sensor of the first cylinder group is at the maximum while a fuel injection amount of the first cylinder group is changed under a consistent operating condition in which fresh air blows from an intake gas channel to an exhaust gas channel through a combustion chamber. The first controlling means further obtains a second output value or a correlated value thereof from the second air fuel ratio sensor for exhaust gas discharged from the second cylinder group when an indicated work or a correlated value thereof based on a detection value of the in-cylinder pressure sensor of the second cylinder group is at the maximum while a fuel injection amount of the second cylinder group is changed under the consistent operating condition. The first controlling means controls at least one of the first valve overlapping period and the second valve overlapping period to reduce an output value difference between the obtained first output value and the obtained second output value or a correlated value difference between the obtained correlated value of the first output value and the obtained correlated value of the second output value.

According to a fourth aspect of the present invention, in the controller according to the third aspect, the supercharger includes: a first turbocharger provided with a first turbine disposed in the first exhaust gas channel, and a second turbocharger provided with a second turbine disposed in the second exhaust gas channel. According to the fourth aspect, in the third aspect, the internal combustion engine further includes a first exhaust gas bypass channel that bypasses the first turbine, a second exhaust gas bypass channel that bypasses the second turbine, a first waist gate valve that opens and closes the first exhaust gas bypass channel, and a second waist gate valve that opens and closes the second exhaust gas bypass channel. According to the fourth aspect, in the third aspect, the input part further connected to the first waist gate valve and the second waist gate valve. According to the fourth aspect, in the third aspect, the controller further includes second controlling means that controls the first waist gate valve and the second waist gate valve. The second controlling means obtains a first indicated work or a correlated value thereof based on the detection value of the in-cylinder pressure sensor of the first cylinder group and a second indicated work or a correlated value thereof based on the detection value of the in-cylinder pressure sensor of the second cylinder group after the first controlling means controls at least one of the first valve overlapping period and the second valve overlapping period to reduce the output value difference or the correlated value difference. The second controlling means controls an opening of at least one of the first waist gate valve and the second waist gate valve to reduce a difference between the obtained first indicated work and the obtained second indicated work or a difference between the obtained correlated value of the first indicated work and the obtained correlated value of the second indicated work.

According to the first aspect and the third aspect of the present invention, by adjusting the fuel injection amount to maximize the indicated work or a correlated value thereof under a consistent operating condition in which blowing of fresh air occurs, the same combustion condition in which the air fuel ratio in the cylinders is the output air fuel ratio (12.5 in the case of gasoline) can be achieved in both the cylinder groups regardless of the effects of the deterioration of the intake and exhaust system over time or the like. As a result, the scavenging amount can be accurately compared between the cylinder groups regardless of the effect described above by comparison of the output values of the air fuel ratio sensors for the exhaust gas discharged from the cylinder groups or the correlated values thereof. According to the present invention, if the output value or the correlated value differs between the cylinder groups (that is, if the scavenging amount differs between the cylinder groups), the difference of the scavenging amount between the cylinder groups can be reduced by adjusting the valve overlapping period.

According to the second aspect and the fourth aspect of the present invention, a torque variation between the cylinder groups as a result of the adjustment of the valve overlapping period for reducing the difference of the scavenging amount between the cylinder groups can be suppressed.

### BRIEF DESCRIPTION OF THE DRAWINGS

FIG. 1 is a diagram for illustrating a system configuration of an internal combustion engine according to an embodiment of the present invention;

FIG. 2 is a graph showing a relationship between the combustion temperature and the equivalence ratio;

FIG. 3 is a graph showing how the indicated torque changes with the air fuel ratio; and

FIG. 4 is a flowchart showing a control routine performed in the embodiment according to the present invention.

### DETAILED DESCRIPTION OF THE PREFERRED EMBODIMENTS

### [System Configuration of Internal Combustion Engine]

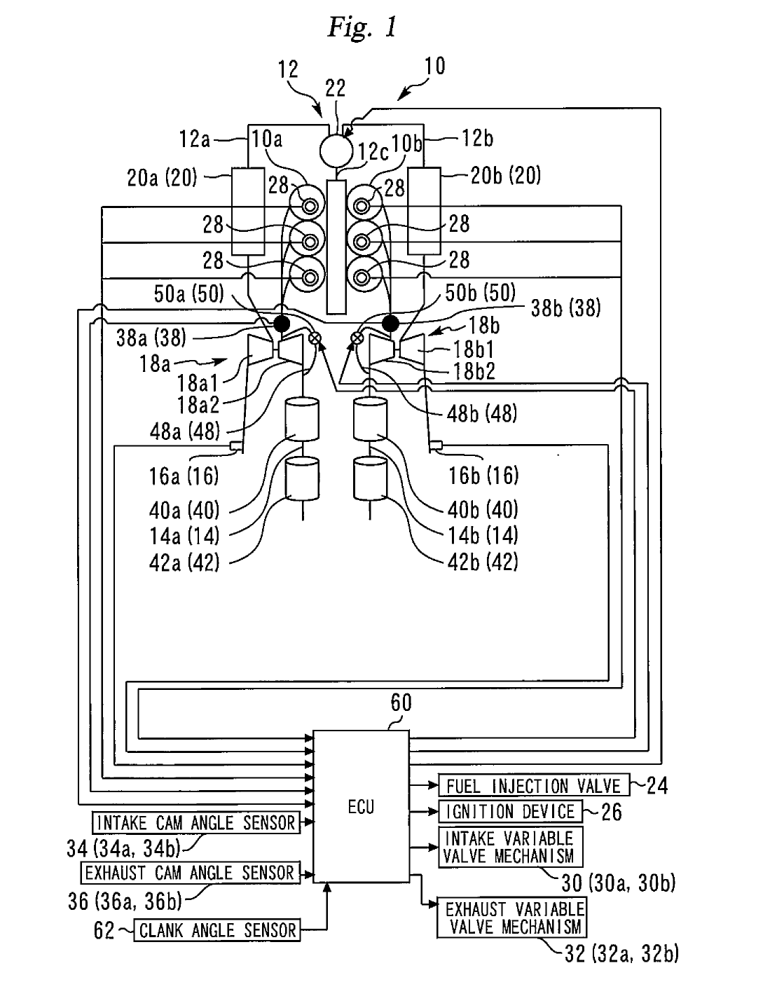

FIG. 1 is a diagram for illustrating a system configuration of an internal combustion engine 10 according to an embodiment of the present invention. The internal combustion engine 10 is a V gasoline engine, for example. In particular, as shown in FIG. 1, the internal combustion engine 10 includes two banks (cylinder blocks): a first bank 10a including three cylinders and a second bank 10b including three cylinders. In the following description, components provided for the banks 10a and 10b will be denoted by reference numerals with a suffix “a” or “b” to indicate whether the components belong to the bank 10a or 10b, although the suffix “a” or “b” may sometimes be omitted if such differentiation is not needed.

The internal combustion engine 10 includes an intake air channel 12 that introduces air to each cylinder and an exhaust gas channel 14 through which exhaust gas discharged from each cylinder flows. More specifically, the intake air channel 12 includes a first intake air channel 12a, a second intake air channel 12b, and a single confluent intake air channel 12c connected to the first intake air channel 12a and the second intake air channel 12b. The exhaust gas channel 14 includes a first exhaust gas channel 14a through which exhaust gas discharged from the first bank 10a flows, and a second exhaust gas channel 14b through which exhaust gas discharged from the second bank 10b flows. Although air is introduced into both the banks 10a and 10b through the single confluent intake air channel 12c in this example, the internal combustion engine may be provided with separate intake air channels that independently introduce air to the respective banks.

A first air flowmeter 16a that outputs a signal responsive to the flow rate of the air introduced to the first intake air channel 12a is provided in the vicinity of an inlet of the first intake air channel 12a. A first compressor 18a1 of a first turbocharger 18a is disposed downstream of the first air flowmeter 16a. The first turbocharger 18a includes a first turbine 18a2 that is integrally coupled with the first compressor 18a1 and operates on the energy of the exhaust gas. A first intercooler 20a that cools the air compressed by the first compressor 18a1 is disposed in the first intake air channel 12a at a point downstream of the first compressor 18a1. Similarly, in order from upstream to downstream, the second intake air channel 12b is provided with a second air flowmeter 16b, a second turbocharger 18b including a second compressor 18b1 and a second turbine 18b2, and a second intercooler 20b.

The first intake air channel 12a and the second intake air channel 12b are merged at a point downstream of the first intercooler 20a and the second intercooler 20b. An electronically controlled throttle valve 22 that adjusts the amount of air flowing through the confluent intake air channel 12c is disposed at the point of merging of the first intake air channel 12a and the second intake air channel 12b. Each of the cylinders of the internal combustion engine 10 is provided with a fuel injection valve 24 that directly injects fuel into the cylinder and an ignition device 26 that ignites the air fuel mixture. Each cylinder is further provided with an in-cylinder pressure sensor 28 that detects the pressure in the cylinder.

The internal combustion engine 10 further includes a first intake variable valve mechanism 30a capable of varying the opening characteristics of an intake valve (not shown) of each cylinder of the first bank 10a, and a first exhaust variable valve mechanism 32a capable of varying the opening characteristics of an exhaust valve (not shown) of each cylinder of the first bank 10a. More specifically, the variable valve mechanisms 30a and 32a are variable valve timing mechanisms that can continuously vary the timings of opening and closing of the intake valve and the exhaust valve within a certain range with a fixed working angle by varying the rotational phase of a cam shaft (not shown) with respect to the rotational phase of a crankshaft (not shown). Furthermore, a first intake cam angle sensor 34a that detects the intake cam angle, which is the rotational angle of the intake cam shaft (not shown) of the first bank 10a, is disposed in the vicinity of the intake cam shaft, and a first exhaust cam angle sensor 36a that detects the exhaust cam angle, which is the rotational angle of the exhaust can shaft (not shown) of the first bank 10a, is disposed in the vicinity of the exhaust cam shaft. Similarly, for the second bank 10b, a second intake variable valve mechanism 30b, a second exhaust variable valve mechanism 32b, a second intake cam angle sensor 34b, and a second exhaust cam angle sensor 36b are provided.

At a point upstream of the first turbine 18a2, the first exhaust gas channel 14a is provided with a first air fuel ratio sensor 38a that detects the air fuel ratio (exhaust air fuel ratio) of the exhaust gas at that point. Similarly, the second exhaust gas channel 14b is provided with a second air fuel ratio sensor 38b. The air fuel ratio sensors 38a and 38b are sensors that provide an output that is substantially linear with respect to the exhaust air fuel ratio.

At a point downstream of the first turbine 18a2, the first exhaust gas channel 14a is provided with two exhaust gas purifying catalysts (three way catalysts, in this example) arranged in series with each other: a first upstream catalyst 40a and a first downstream catalyst 42a. Similarly, the second exhaust gas channel 14b is provided with two catalysts arranged in series with each other: a second upstream catalyst 40b and a second downstream catalyst 42b.

A first exhaust gas bypass channel 48a is connected to the first exhaust gas channel 14a between the inlet side and the outlet side of the first turbine 18a2. The first exhaust gas bypass channel 48a is provided with a first waist gate valve (WGV) 50a that opens and closes the first exhaust gas bypass channel 48a at a midpoint thereof. Similarly, the second exhaust gas channel 14b is provided with a second exhaust gas bypass channel 48b and a second WGV 50b.

The system shown in FIG. 1 further includes an electronic control unit (ECU) 60. The air flowmeter 16, the in-cylinder pressure sensor 28, the intake cam angle sensor 34, the exhaust cam angle sensor 36 and the air fuel ratio sensor 38 described above as well as various types of sensors that detect the operating state of the internal combustion engine 10, such as a crank angle sensor 62 that detects the crank angle and the engine speed, are connected to an input part of the ECU 60. Various types of actuators that control the operation of the internal combustion engine 10, such as the throttle valve 22, the fuel injection valve 24, the ignition device 26, the intake variable valve mechanism 30, the exhaust variable valve mechanism 32 and the WGV 50 described above, are connected to an output part of the ECU 60. The ECU 60 conducts a predetermined engine control, such as fuel injection control and ignition control, by making the various types of actuators operate based on outputs of the various types of sensors described above according to a predetermined program. The ECU 60 further has a function of AD-converting the output signal from the in-cylinder pressure sensor 28 in synchronization with the crank angle. Therefore, the in-cylinder pressure at any crank angle timing can be detected within a range allowed by the resolution of the AD conversion. The ECU 60 further has a function of calculating the value of the cylinder volume, which is determined by the angular position of the crank, according to the crank angle.

[Scavenging Effect Achieved by Blowing of Fresh Air from Intake Air Channel to Exhaust Gas Channel through Combustion Chamber]

The variable valve mechanisms 30 and 32 configured as described above can increase or decrease the valve overlapping period in which the intake valve and the exhaust valve are both open by changing at least one of the value of the advance of opening or closing of the intake valve and the value of the delay of opening or closing of the exhaust valve. With the internal combustion engine 10 according to this embodiment provided with the turbochargers 18, the intake air pressure (at a point downstream of the throttle valve 22) is higher than the exhaust gas pressure (exhaust manifold pressure) in the low-speed high-load region because of the supercharging by the turbochargers 18. If the valve overlapping period is set in the low-speed high-load region in which such a pressure condition holds, a phenomenon occurs in which fresh air (intake air) blows from the intake air channel 12 to the exhaust gas channel 14 through the combustion chamber (this phenomenon is referred to simply as scavenging, hereinafter). The fresh air from the intake air channel 12 scavenges and replaces the residual gas in the cylinders that would otherwise present in the cylinders in amounts of the clearance volume of the combustion chamber (this phenomenon is referred to as scavenging effect). This offers advantages, such as an increase of torque and an improvement of supercharging response, to the internal combustion engine 10. Therefore, in this embodiment, the valve overlapping period is set in the low-speed high-load region in which the intake air pressure is higher than the exhaust gas pressure in order to take advantage of the scavenging effect. In the following description, the amount of fresh air blowing to the exhaust gas channel 14 in one scavenging will be referred to as “scavenging amount”.

### [Method of Evaluating Scavenging Amount of Each Bank]

In the internal combustion engine provided with two cylinder groups, such as the V internal combustion engine 10 provided with the banks 10a and 10b, the pressure of the gas flowing into the cylinders (intake gas pressure) or the pressure of the gas discharged from the cylinders (exhaust gas pressure) may differ between the cylinder groups because of plugging over time of the catalysts or other components disposed in the exhaust gas channels, pressure losses or variations in the components of the intake and exhaust system, or deterioration of the superchargers over time. Even if the cylinder groups have the same valve overlapping period, the scavenging amount differs between the cylinder groups if the difference between the intake gas pressure (more specifically, the intake manifold pressure, that is, the supercharging pressure) and the exhaust gas pressure (more specifically, the exhaust manifold pressure) differs between the cylinder groups.

In estimation of the scavenging amount, if the effect of such deterioration over time or the like fails to be grasped, the fuel injection amount cannot be adjusted to achieve an appropriate air fuel ratio in the cylinders of the cylinder groups. If the actual scavenging amount is greater than a reference scavenging amount (an appropriate amount adapted in advance for a new internal combustion engine) because of the relationship between the operating condition (the engine speed and the engine load factor) of the internal combustion engine and the valve overlapping period, a problem occurs as described below. Oxygen in the fresh air blowing through the combustion chamber during excessive scavenging is trapped (stored) in the catalyst. Since the amount of air actually filling the cylinder during blowing of fresh air (cylinder filling air amount) is determined by subtracting the scavenging amount from the amount of air passing through the intake valve and flowing into the cylinder (intake valve passing air amount), the air fuel ratio during combustion in the cylinder is richer than the theoretical air fuel ratio if the fuel injection amount is controlled to achieve the theoretical air fuel ratio that is determined based on the intake valve passing air amount. The rich gas (gas having an air fuel ratio richer than the theoretical air fuel ratio and containing unburned fuel) discharged from the cylinder flows to the catalyst, and the unburned fuel in the rich gas reacts with the oxygen trapped in the catalyst. The oxidation can result in overheating of the catalyst bed and decrease of fuel efficiency. If the actual scavenging amount is smaller than the reference scavenging amount, the oxidation of the unburned fuel with the oxygen in the fresh air in the catalyst is suppressed, although the inadequate scavenging amount can cause deterioration of supercharging response or decrease of fuel efficiency. In this embodiment, the method described below is used to estimate the scavenging amount of each cylinder group regardless of the effects of the deterioration of the intake and exhaust system over time or the like.

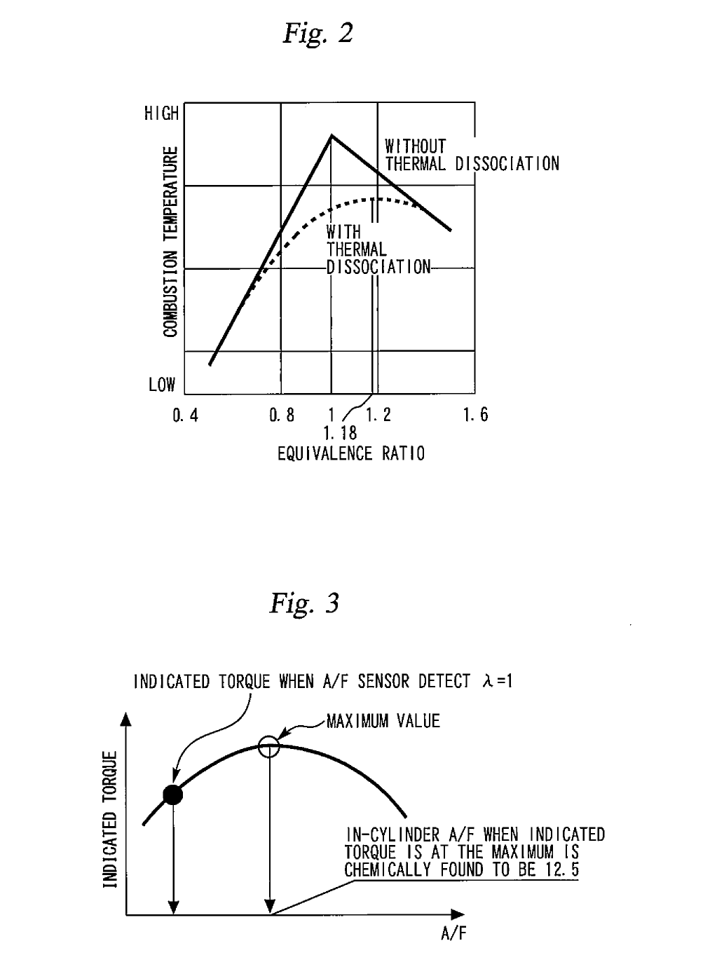

FIG. 2 is a graph showing a relationship between the combustion temperature and the equivalence ratio. FIG. 3 is a graph showing how the indicated torque changes with the air fuel ratio. Actual combustion of the hydrocarbon fuel in the cylinder involves thermal dissociation. Therefore, as shown in FIG. 2, the maximum value of the combustion temperature during actual combustion (indicted by the dashed line) is lower than that in the case where thermal dissociation does not occur (indicated by the solid line) and is reached at an air fuel ratio (12.5 (approximately 1.18 in terms of equivalence ratio) in the case of gasoline) richer than the theoretical air fuel ratio. As shown in FIG. 3, the maximum value of the torque (indicated torque) of the internal combustion engine 10 produced by combustion is also reached at the air fuel ratio of 12.5 (referred to as an output air fuel ratio) at which the combustion temperature is at the maximum.

Since the internal combustion engine 10 according to this embodiment is provided with the in-cylinder pressure sensors 28, the indicated torque can be calculated using the detection value of the in-cylinder pressure sensor 28, or more specifically, using the history of the in-cylinder pressure P in one cycle detected by the in-cylinder pressure sensor 28 and the variation dV of the cylinder volume V. The indicated work can be calculated by integrating the product of the cylinder pressure P and the variation dV of the cylinder volume V over one cycle according to the following formula (1). The indicated work is the amount of work done by the working fluid in the cylinder on the piston in one cycle.

Indicated work=∫P·dV (1)

The indicated mean effective pressure can be calculated by dividing the indicated work calculated according to the formula (1) by the piston displacement. The indicated torque can be determined from the indicated mean effective pressure according to a known relation.

In this embodiment, the fuel injection amount is changed for each cycle on a bank basis under a consistent operating condition in which scavenging (blowing of fresh air) occurs, and the exhaust gas air fuel ratio is obtained for each bank when the indicated torque based on the detection value of the in-cylinder pressure sensor 28 is at the maximum. The “consistent operating condition in which scavenging occurs” referred to herein means a steady operating condition in which the intake gas pressure is higher than the exhaust gas pressure and the low-speed high-load region in which the valve overlapping period is set is used (in particular, an operating condition in which the engine speed and the engine load factor do not change in a cycle in which the indicated torque is calculated).

The combustion condition in which the indicated torque is at the maximum can be achieved by calculating the indicated torque by gradually changing the fuel injection amount until the indicated torque is at the maximum under the consistent operating condition described above. Alternatively, the method described below may be used, for example. The curve representing the relationship between the indicated torque and the air fuel ratio is a quadric curve as shown in FIG. 3. In this example, since a steady operating condition in which the engine load factor (that is, the intake air amount) is constant is assumed, the curve representing the relationship between the indicated torque and the fuel injection amount is also a quadric curve. Thus, the combustion condition in which the indicated torque is at the maximum may be achieved by obtaining the indicated torque at at least three points while changing the fuel injection amount, determining a quadric curve that passes through the at least three points that represents the relationship between the indicated torque and the fuel injection amount on a X-Y plane, and estimating the fuel injection amount at the time when the quadric curve is at the maximum. The combustion condition in which the indicated torque is at the maximum can be achieved by injecting the estimated amount of fuel. The air fuel ratio of the exhaust gas discharged from the cylinder in the cycle in which the combustion condition is achieved can be derived from the output value of the air fuel ratio sensor 38 at the time when the exhaust gas reaches the air fuel ratio sensor 38. The time when the exhaust gas discharged from the cylinder reaches the air fuel ratio sensor 38 can be estimated from the distance on the exhaust gas channel 14 between the exhaust valve and the air fuel ratio sensor 38 and the transportation time of the exhaust gas, and the transportation time of the exhaust gas can be estimated from the engine speed or the like, for example.

The air fuel ratio in the cylinder during scavenging is essentially unknown. However, the air fuel ratio in the cylinder at the time when the indicated torque is at the maximum is chemically found to be 12.5 (output air fuel ratio). According to the method according to this embodiment, the exhaust gas air fuel ratio at the time when the air fuel ratio in the cylinder is the output air fuel ratio can be determined regardless of the effect of the above-described deterioration over time of the intake and exhaust system or the like.

According to this embodiment, the scavenging ratio, which indicates the extent of the scavenging amount is calculated by using the exhaust gas air fuel ratio at the time when the indicated torque is at the maximum (that is, when the air fuel ratio in the cylinder is the output air fuel ratio). The scavenging ratio used herein is determined by dividing the difference between the exhaust gas air fuel ratio and the output air fuel ratio by the output air fuel ratio as shown by the following formula (2).

Scavenging ratio=(exhaust air fuel ratio−output air fuel ratio)/output air fuel ratio×100 (2)

The “scavenging ratio” referred to herein corresponds to the ratio of the scavenging amount to the amount of air filing the cylinder. For example, when the detected exhaust gas air fuel ratio is 15.5, the scavenging ratio is 24% if the output air fuel ratio is 12.5. Since the intake valve passing air amount can be detected by the air flowmeter 16, the scavenging amount can be calculated from the intake valve passing air amount and the scavenging ratio.

According to the method described above, the scavenging ratio and the scavenging amount can be estimated as far as the exhaust gas air fuel ratio at the time when the indicated torque is at the maximum under the consistent operating condition described above can be determined from the outputs of the in-cylinder pressure sensor 28 and the air fuel ratio sensor 38. The output air fuel ratio is not affected by the above-described deterioration of the intake and exhaust system over time or the like and therefore is chemically kept around 12.5. Therefore, the scavenging ratio and the scavenging amount can be estimated regardless of the effect described above.

### [Control of Scavenging Amount for Each Bank]

According to the method of estimating the scavenging ratio (amount) described above, by adjusting the fuel injection amount so as to achieve the maximum indicated torque under the consistent operating condition described above, the same combustion condition in which the air fuel ratio in the cylinder is 12.5 (output air fuel ratio) can be achieved in the banks 10a and 10b regardless of the effect of the deterioration of the intake and exhaust system or the like. As a result, the scavenging amount can be accurately compared between the banks 10a and 10b by comparing the exhaust gas air fuel ratio (value from the air fuel ratio sensor) between the banks 10a and 10b. According to this embodiment, if the estimated value of the scavenging amount differs between the banks, the valve overlapping period for one of the banks 10a and 10b is adjusted to reduce the difference.

Specifically, in the case where the exhaust gas temperature is equal to or lower than a predetermined value, if the scavenging amount differs between the banks, the valve overlapping period of one of the banks 10a and 10b that has the smaller scavenging amount is extended to make the scavenging amount of that bank agree with the scavenging amount of the other bank. In the case where the exhaust gas temperature is higher than the predetermined value, however, if the valve overlapping period is extended to increase the scavenging amount, the catalyst temperature may increase beyond a predetermined temperature range (appropriate temperature range of the catalyst set on the assumption that the catalyst is new). In view of this, if the scavenging amount differs between the banks in the case where the exhaust gas temperature is higher than the predetermined value, the valve overlapping period of one of the banks 10a and 10b that has the greater scavenging amount is shortened to make the scavenging amount of that bank agree with the scavenging amount of the other bank. The predetermined value of the exhaust gas temperature is a value previously determined as a threshold of the exhaust gas temperature so as to prevent the catalyst temperature from excessively increasing as the scavenging amount increases.

If the valve overlapping period is adjusted to adjust the scavenging amounts of the banks, the amount of air flowing into the cylinders changes, and the torque produced in the cylinders changes. According to this embodiment, after the valve overlapping period is adjusted, it is determined whether or not the indicated torque differs between the banks. If the indicated torque differs between the banks, the relevant WGV 50 is regulated to reduce the difference.

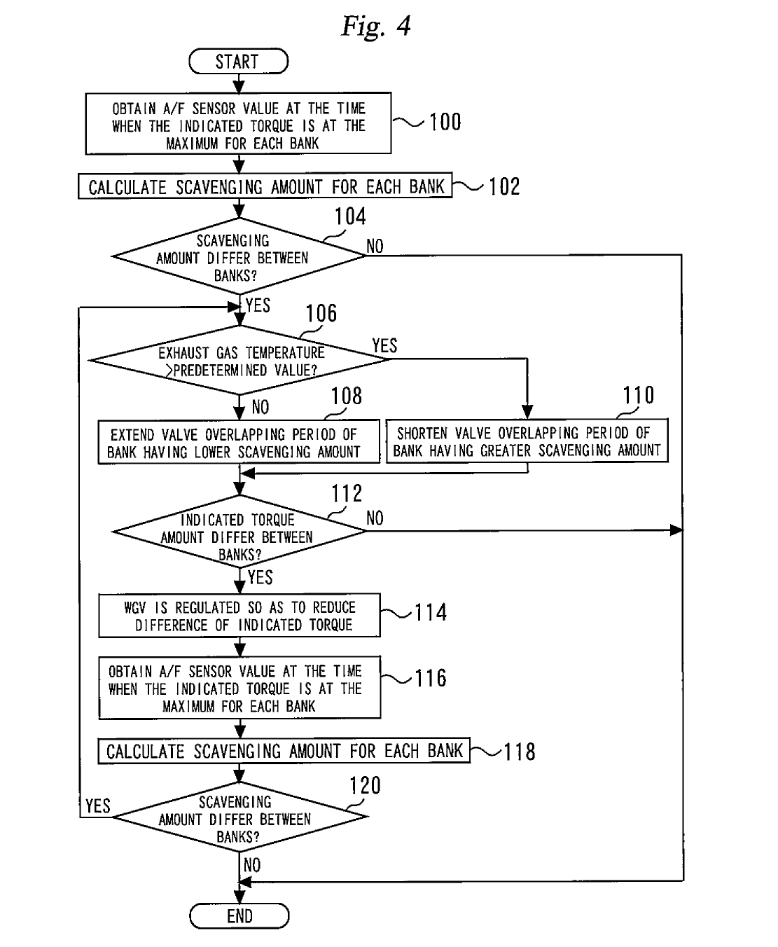

FIG. 4 is a flowchart showing a control routine performed by the ECU 60 to implement the characteristic control described above. The processing of this routine is activated and performed under a steady operating condition in which scavenging occurs. More specifically, a low-speed high-load region (supercharging region) in which scavenging may be previously determined and stored in the ECU 60, and this routine may be performed when a steady operation occurs in the low-speed high-load region. Alternatively, this routine may be performed when the operating condition described above is deliberately established to perform the routine.

According to the routine shown in FIG. 4, in step 100, the ECU 60 first obtains the exhaust gas air fuel ratio at the time when the indicated torque is at the maximum under the consistent operating condition described above from the air fuel ratio sensor 38 for each bank. The indicated torque for each of the banks 10a and 10b may be calculated for one arbitrarily chosen representative cylinder or calculated as an average of the indicated torques of the plurality of cylinders of the bank.

Then, the ECU 60 proceeds to step 102, where the ECU 60 calculates the scavenging amount for each bank from the obtained exhaust gas air fuel ratio according to the formula (2) described above. Then, the ECU 60 proceeds to step 104, where the ECU 60 determines whether or not the scavenging amount differs between the banks. If the result of the determination is negative, the processing of this routine immediately ends.

If it is determined that the scavenging amount differs between the banks, the ECU 60 proceeds to step 106, where the ECU 60 determines whether or not the exhaust gas temperature is higher than the predetermined value. The predetermined value of the exhaust gas temperature used in this step 106 is a value previously determined taking into consideration the increase of the catalyst temperature with the increase of the scavenging amount and the predetermined temperature range of the catalyst temperature.

If it is determined in step 106 that the exhaust gas temperature is equal to or lower than the predetermined value, the ECU 60 proceeds to step 108, where the valve overlapping period of one of the banks 10a and 10b that has the lower scavenging amount is extended to make the scavenging amount of that bank agree with the scavenging amount of the other bank. More specifically, for example, the valve overlapping period of one of the banks 10a and 10b that has the lower scavenging amount is extended by a predetermined length of time to bring the scavenging amount of that bank closer to the scavenging amount of the other bank. This adjustment of the valve overlapping period is not exclusively achieved with the variable valve mechanisms 30 and 32 that adjust the timings of opening and closing of the valves with a fixed working angle. For example, if there is provided a variable valve mechanism that can vary the working angle of at least one of the intake valve and the exhaust valve, the working angle can be adjusted to adjust at least one of the timing of opening of the intake valve and the timing of closing of the exhaust valve in order to adjust the valve overlapping period.

If it is determined in step 106 that the exhaust gas temperature is higher than the predetermined value, the ECU 60 proceeds to step 110, where the valve overlapping period of one of the banks 10a and 10b that has the greater scavenging amount is shortened (by a predetermined amount, for example) to make the scavenging amount of that bank agree with the scavenging amount of the other bank.

After the processing in step 108 or 110 is performed, the ECU 60 proceeds to step 112, where the indicated torque is calculated for each bank, and it is determined whether or not the indicated torque differs between the banks. If the result of the determination in step 112 is negative, the processing of this routine immediately ends. If it is determined that the indicated torque differs between the banks, the ECU 60 proceeds to step 114, where the relevant WGV 50 is regulated so as to reduce the difference of the indicated torque between the banks. More specifically, for example, the opening of one or both of the WGVs 50 is adjusted to compensate for the variation in intake air amount due to the adjustment of the scavenging amount in step 108 or 110. For example, in order to recover a certain amount of intake air, the WGV 50 is closed by a predetermined amount.

After the processing in step 114 is performed, the ECU 60 successively performs the processings in steps 116 and 118, which are the same as steps 100 and 102, respectively, to obtain the scavenging amount for each bank. Then, the ECU 60 proceeds to step 120, where it is determined again whether or not the scavenging amount differs between the banks. If the result of the determination is positive, the processings in step 106 and the following steps are repeated. If the result of the determination is negative, that is, if the scavenging amounts of the banks 10a and 10b can be made to agree with each other in the state where the indicated torques of the banks 10a and 10b agree with each other, this control routine ends.

According to the routine shown in FIG. 4 described above, the scavenging amount of each cylinder group can be evaluated (monitored) based on the exhaust gas air fuel ratio regardless of the effect of the deterioration of the intake and exhaust system or the like. If the scavenging amount differs between the banks, the difference in scavenging amount between the banks (including the difference due to the effect described above) can be reduced by adjusting the valve overlapping period on a bank basis. More specifically, if the exhaust gas temperature is equal to or lower than the predetermined value (or in other words, if the exhaust gas temperature is considerably lower than the upper limit of the appropriate exhaust gas temperature range), the valve overlapping period of one of the banks 10a and 10b that has the smaller scavenging amount is adjusted to make the scavenging amount of that bank agree with the scavenging amount of the other bank. In this way, high torque can be achieved in the state where the same cylinder air fuel ratio is achieved in the banks. Therefore, even if the scavenging amount of one of the banks 10a and 10b has decreased because of catalyst plugging, for example, the decrease in torque over time can be eliminated, and a torque close to the original torque (torque of the new internal combustion engine) can be achieved. If the exhaust gas temperature is higher than the predetermined value, the valve overlapping period of one of the banks 10a and 10b that has the greater scavenging amount is adjusted to make the scavenging amount of that bank agree with the scavenging amount of the other bank. In this case, in a situation where an increase of the scavenging amount may cause overheating of the catalyst, the higher of the exhaust gas temperatures of the banks 10a and 10b can be adjusted to the lower of the exhaust gas temperatures of the banks 10a and 10b.

In addition, according to the routine described above, after the valve overlapping period is adjusted to adjust the scavenging amount, the WGV 50 is regulated to make the indicated torques of the banks agree with each other. In this way, the torque variation between the banks due to the adjustment of the valve overlapping period can be suppressed.

In the embodiment described above, the indicated torque based on the detection value from the in-cylinder pressure sensor 28 is used to achieve the combustion condition in which the air fuel ratio in the cylinder is the output air fuel ratio. However, the value used for this purpose in the present invention may be the indicated work itself that is calculated from the detection value from the in-cylinder pressure sensor 28. Values other than the indicated torque that can be used for this purpose include the indicated mean effective pressure, for example.

In the embodiment described above, the scavenging amount is calculated based on the output value of the air fuel ratio sensor 38 obtained when the indicated torque is at the maximum and compared between the banks. However, the comparison of the scavenging amount between the banks according to the present invention is not exclusively made based on the calculated scavenging amount. For example, the output value (voltage value) of the air fuel ratio sensor 38 may be directly compared between the banks. Alternatively, a correlated value of the output value of the air fuel ratio sensor 38 may be compared between the banks. The correlated value referred to herein may be the scavenging amount or the scavenging ratio described in the embodiment or an air fuel ratio index (air fuel ratio, excess air ratio, or equivalence ratio) calculated from the output value.

In the embodiment described above, in order that the difference of the scavenging amount (exhaust gas air fuel ratio) between the banks decreases, the greater (or smaller) of the scavenging amounts of the banks 10a and 10b is adjusted to agree with the other scavenging amount. However, the adjustment of the valve overlapping period for adjusting the scavenging amount according to the present invention may be made in other ways such as described below. For example, an appropriate value of the output value of the air fuel ratio sensor 38 or a correlated value thereof may be stored in association with the operating condition in the ECU 60. Then, the valve overlapping period of each of the banks 10a and 10b may be adjusted to eliminate the difference between the output value of the air fuel ratio sensor 38 of each of the banks 10a and 10b or the correlated value thereof obtained under the consistent operating condition and the appropriate value. Alternatively, the valve overlapping period of each of the banks 10a and 10b may be adjusted to, as a target value, an average of the output values of the air fuel ratio sensors 38 of the banks 10a and 10b or correlated values thereof obtained under the consistent operating condition.

In the embodiment described above, the V internal combustion engine 10 provided with two banks 10a and 10b has been described as an example. However, the internal combustion engine to which the present invention can be applied is not limited to the V internal combustion engine described above but may be a straight internal combustion engine or a horizontally opposed internal combustion engine as far as the internal combustion engine has two cylinder groups and the exhaust gas channels connected to the cylinder groups are independently provided with a catalyst, a turbine and other devices that produce pressure losses.

In the embodiment described above, the internal combustion engine 10 provided with turbochargers 18 has been described as an example. However, the internal combustion engine according to the present invention may not be provided with turbochargers, and may be provided with a supercharger that uses motive power of the crankshaft of the internal combustion engine or with an electric motor. Note that, in the above sentence, the “supercharger” is a superordinate concept that includes a turbocharger, a mechanical supercharger, and a supercharger with electric motor.

In the embodiment described above, the “first controlling means” according to the third aspect of the present invention is implemented by the ECU 60 performing the processings in steps 100 to 110 and 116 to 120.

The “second controlling means” according to the fourth aspect of the present invention is implemented by the ECU 60 performing the processings in steps 112 and 114.

1. An internal combustion engine comprising:
a first cylinder group including at least one cylinder having an intake valve and an exhaust valve;
a second cylinder group including at least one cylinder having an intake valve and an exhaust valve;
a supercharger that supercharges intake air;
a fuel injection valve provided for each cylinder of the first cylinder group and the second cylinder group, the fuel injection valve directly injecting fuel into the cylinder;
a first exhaust gas channel connected to the first cylinder group;
a second exhaust gas channel connected to the second cylinder group;
a first air fuel ratio sensor that detects an air fuel ratio of exhaust gas flowing through the first exhaust gas channel;
a second air fuel ratio sensor that detects an air fuel ratio of exhaust gas flowing through the second exhaust gas channel;
in-cylinder pressure sensors provided for at least one cylinder of the first cylinder group and at least one cylinder of the second cylinder group;
a first variable valve mechanism capable of adjusting a first valve overlapping period in which both the intake valve and the exhaust valve of the first cylinder group are open;
a second variable valve mechanism capable of adjusting a second valve overlapping period in which both the intake valve and the exhaust valve of the second cylinder group are open; and
a controller that controls the first variable valve mechanism and the second variable valve mechanism, the controller programmed to:
(i) obtain a first output value or a correlated value thereof from the first air fuel ratio sensor for exhaust gas discharged from the first cylinder group when an indicated work or a correlated value thereof based on a detection value of the in-cylinder pressure sensor of the first cylinder group is at the maximum while a fuel injection amount of the first cylinder group is changed under a consistent operating condition in which fresh air blows from an intake gas channel to an exhaust gas channel through a combustion chamber,
(ii) obtain a second output value or a correlated value thereof from the second air fuel ratio sensor for exhaust gas discharged from the second cylinder group when an indicated work or a correlated value thereof based on a detection value of the in-cylinder pressure sensor of the second cylinder group is at the maximum while a fuel injection amount of the second cylinder group is changed under the consistent operating condition, and
(iii) control at least one of the first valve overlapping period and the second valve overlapping period to reduce an output value difference between the obtained first output value and the obtained second output value or a correlated value difference between the obtained correlated value of the first output value and the obtained correlated value of the second output value.

2. The internal combustion engine according to claim 1, wherein
the supercharger includes:
a first turbocharger provided with a first turbine disposed in the first exhaust gas channel, and
a second turbocharger provided with a second turbine disposed in the second exhaust gas channel,
wherein the internal combustion engine further comprises:
a first exhaust gas bypass channel that bypasses the first turbine,
a second exhaust gas bypass channel that bypasses the second turbine,
a first waist gate valve that opens and closes the first exhaust gas bypass channel,
a second waist gate valve that opens and closes the second exhaust gas bypass channel,
and wherein the controller further programmed to:
(i) obtain a first indicated work or a correlated value thereof based on the detection value of the in-cylinder pressure sensor of the first cylinder group and a second indicated work or a correlated value thereof based on the detection value of the in-cylinder pressure sensor of the second cylinder group after the controller controls at least one of the first valve overlapping period and the second valve overlapping period to reduce the output value difference or the correlated value difference, and
(ii) control an opening of at least one of the first waist gate valve and the second waist gate valve to reduce a difference between the obtained first indicated work and the obtained second indicated work or a difference between the obtained correlated value of the first indicated work and the obtained correlated value of the second indicated work.

3. A controller for an internal combustion engine provided with a first cylinder group including at least one cylinder, second cylinder group including at least one cylinder, a supercharger that supercharges intake air, a fuel injection valve provided for each cylinder of the first cylinder group and the second cylinder group, the fuel injection valve directly injecting fuel into the cylinder, a first exhaust gas channel connected to the first cylinder group, a second exhaust gas channel connected to the second cylinder group, a first air fuel ratio sensor that detects an air fuel ratio of exhaust gas flowing through the first exhaust gas channel, a second air fuel ratio sensor that detects an air fuel ratio of exhaust gas flowing through the second exhaust gas channel, in-cylinder pressure sensors provided for at least one cylinder of the first cylinder group and at least one cylinder of the second cylinder group, a first variable valve mechanism capable of adjusting a first valve overlapping period in which both an intake valve and an exhaust valve of the first cylinder group are open, a second variable valve mechanism capable of adjusting a second valve overlapping period in which both an intake valve and an exhaust valve of the second cylinder group are open, the controller comprising:
an input part connected to the first air fuel ratio sensor and the second air fuel ratio sensor;
an output part connected to the first variable valve mechanism and the second variable valve mechanism; and
first controlling means that controls the first variable valve mechanism and the second variable valve mechanism,
wherein the first controlling means
obtains a first output value or a correlated value thereof from the first air fuel ratio sensor for exhaust gas discharged from the first cylinder group when an indicated work or a correlated value thereof based on a detection value of the in-cylinder pressure sensor of the first cylinder group is at the maximum while a fuel injection amount of the first cylinder group is changed under a consistent operating condition in which fresh air blows from an intake gas channel to an exhaust gas channel through a combustion chamber,
obtains a second output value or a correlated value thereof from the second air fuel ratio sensor for exhaust gas discharged from the second cylinder group when an indicated work or a correlated value thereof based on a detection value of the in-cylinder pressure sensor of the second cylinder group is at the maximum while a fuel injection amount of the second cylinder group is changed under the consistent operating condition, and
controls at least one of the first valve overlapping period and the second valve overlapping period to reduce an output value difference between the obtained first output value and the obtained second output value or a correlated value difference between the obtained correlated value of the first output value and the obtained correlated value of the second output value.

4. The controller according to claim 3, wherein
the supercharger includes:
a first turbocharger provided with a first turbine disposed in the first exhaust gas channel, and
a second turbocharger provided with a second turbine disposed in the second exhaust gas channel,
wherein the internal combustion engine further includes:
a first exhaust gas bypass channel that bypasses the first turbine,
a second exhaust gas bypass channel that bypasses the second turbine,
a first waist gate valve that opens and closes the first exhaust gas bypass channel, and
a second waist gate valve that opens and closes the second exhaust gas bypass channel,
wherein the output part further connected to the first waist gate valve and the second waist gate valve, and
the controller further comprises second controlling means that controls the first waist gate valve and the second waist gate valve,
wherein the second controlling means
obtains a first indicated work or a correlated value thereof based on the detection value of the in-cylinder pressure sensor of the first cylinder group and a second indicated work or a correlated value thereof based on the detection value of the in-cylinder pressure sensor of the second cylinder group after the first controlling means controls at least one of the first valve overlapping period and the second valve overlapping period to reduce the
output value difference or the correlated value difference, and controls an opening of at least one of the first waist gate valve and the second waist gate valve to reduce a difference between the obtained first indicated work and the obtained second indicated work or a difference between the obtained correlated value of the first indicated work and the obtained correlated value of the second indicated work.
